(19) United States
(12) Patent Application Publication
(10) Pub. No.: US 2026/0341572 A1
(43) Pub. Date: Oct. 29, 2026

(54) THREE-PHASE TRANSFORMER FOR ISOLATED VOLTAGE CONVERTER

(71) Applicant: VALEO ELECTRIFICATION, Cergy Pontoise (FR)

(72) Inventors: Amaury ROUET, Cergy Pontoise (FR); Wendell DA-CUNHA-ALVES, Cergy Pontoise (FR); Roger DENIOT, Cergy Pontoise (FR); Massourang DIALLO, Cergy Pontoise (FR); Baptiste PARIGOT, Cergy Pontoise (FR)

(73) Assignee: VALEO ELECTRIFICATION, Cergy Pontoise (FR)

(21) Appl. No.: 19/133,050

(22) PCT Filed: Nov. 28, 2023
(86) PCT No.: PCT/EP2023/083429

§ 371 Date: May 27, 2025

(30) Foreign Application Priority Data
Dec. 8, 2022 (FR) FR2212962

(51) Int. Cl. H01F 27/02; H01F 27/24; H01F 27/28

(52) U.S. Cl. CPC H01F 27/02; H01F 27/24; H01F 27/28

(57) ABSTRACT

An electronic component includes a magnetic circuit, and two electrical conductors each having a portion that is arranged around the same part of the magnetic circuit, each of the portions forming, between a first end and a second end, a winding, these two windings being inductively coupled to one another via the magnetic circuit. A support for the two electrical windings is arranged between the electrical conductors and the portion of the magnetic circuit. The support includes a wall around which the electrical windings are arranged; and at least two ribs that extend away from the wall in the direction of the portion of the magnetic circuit.

The present invention relates to an electronic component comprising a magnetic circuit, and at least two electrical conductors each having a portion arranged around one and the same part of the magnetic circuit, each of said portions forming a winding between a first and a second end, these two windings being inductively coupled to one another via the magnetic circuit.

Such an electronic component defines, for example, a three-phase transformer for an isolated voltage converter, such a voltage converter being, for example, integrated into a component for supplying electric power to a vehicle electrical energy storage unit, also called a “charger” for this electrical energy storage unit. The electrical energy storage unit is, for example, a battery, which can have a nominal voltage greater than 60 V, for example greater than or equal to 300 V, 400 V, 800 V, or even 1000 V. The voltage converter receives, for example, an AC voltage from an electrical network and provides the battery with a DC voltage. This converter may convey a power greater than 5 kW, for example greater than 7 kW, for example greater than 11 kW, in particular of 22 kW or more.

The electronic component comprises in a known manner:
a magnetic circuit,
two electrical conductors each having a portion arranged around one and the same part of the magnetic circuit, each of said portions forming a winding between a first and a second end, these two windings being inductively coupled to one another via the magnetic circuit, and
a support of the two electrical windings, arranged between said electrical conductors and said portion of the magnetic circuit.

There is a need to improve the heat dissipation in the magnetic circuit and to reduce the copper losses in such a component.

The invention seeks to address this need and does so, according to one of its aspects, by means of an electronic component, comprising:
a magnetic circuit,
two electrical conductors each having a portion arranged around one and the same part of the magnetic circuit, each of said portions forming a winding between a first and a second end, these two windings being inductively coupled to one another via the magnetic circuit, and
a support of the two electrical windings, arranged between said electrical conductors and said portion of the magnetic circuit,
characterized by the fact that the support comprises:
a wall around which the electrical windings are arranged, and
at least two ribs extending away from the wall in the direction of the portion of the magnetic circuit.

The presence of the ribs makes it possible to extend the electrical windings further away from the portion of the magnetic circuit around which they are arranged, thus reducing the copper losses in the electronic component. Moreover, the presence of these ribs also makes it possible to create an empty space between this portion of the magnetic circuit and the support in the areas devoid of ribs, a space occupied by a thermally conductive resin, this promoting the cooling of the magnetic circuit.

The support comprises, for example, four, or six, or eight ribs, each extending away from the wall in the direction of the portion of the magnetic circuit. However, the invention is not limited to a particular number of ribs.

Each rib may have the same shape. As will be seen below, the wall of the support may define a hollow cylinder of circular cross section. In this case, each rib may extend radially, that is to say along a radius of this cylinder, in a plane perpendicular to its axis.

The ribs may be distributed uniformly while moving around the wall of the support. In other words, when moving around this wall, the gap between two successive ribs may remain constant.

The support may comprise three edges offset along the longitudinal axis of the support so that one of the electrical windings is arranged between the first and the second edge and that the other of the electrical windings is arranged between the second and the third edge. In other words, the two electrical windings supported by a support of the electrical conductors may follow one another along this support, without overlapping in planes perpendicular to the longitudinal axis of this support.

All or some of the ribs may extend continuously along the axis of the support from the first edge up to the third edge. As a variant, all or some of the ribs extend discontinuously along the axis of the support from the first edge up to the third edge.

All or some of the ribs may extend up to the portion of the magnetic circuit with contact with this portion. In other words, in this case, the radial space existing between the wall and the magnetic circuit is locally entirely filled by the rib. As a variant, a radial clearance may exist between the rib and the magnetic circuit.

In all of the above, the wall around which the electrical windings are arranged may define a hollow cylinder of circular cross section.

Within the meaning of the present application:
“axially” means “along the axis of the wall around which the electrical windings are arranged”,
“angularly” means “while moving around this axis”, and
“radially” means “in a plane perpendicular to this axis, along a straight line cutting through this axis when this wall defines a hollow cylinder of circular cross section”.

Each electrical conductor is, for example, made of Litz wire.

In all of the above, the support may be made in one piece, being, for example, made of, for example, plastic such as polybutylene terephthalate (PBT), or polyamide (PA).

In all of the above, the electronic component may define a transformer for an isolated voltage converter.

In all of the above, no cooling chamber using a liquid is, for example, interposed between the electrical windings and the portion of the magnetic circuit on which the support is arranged.

The transformer is, for example, a three-phase transformer for an isolated voltage converter, comprising three supports of electrical conductors, each support being arranged around a part of the magnetic circuit and bearing two windings inductively coupled to one another via the magnetic circuit, the supports defining, in particular, a geometric pattern of an equilateral triangle.

Each support thus bears two windings which are inductively coupled to one another and which together define one phase of the three-phase transformer.

Arranging the three supports of the electrical conductors in an equilateral triangle may make it possible to guarantee that electrical parameters such as the inductances of the electrical windings are balanced and to reduce the magnetic volume.

The magnetic circuit may be made up of two parts, each part defining a base bearing pins, superposed two by two when these two parts are assembled, and the superposition of two pads defines the part of the magnetic circuit on which a support of the two electrical conductors is mounted. Another object of the invention, according to another of its aspects, is a component for supplying electric power to a vehicle electrical energy storage unit, comprising the transformer defined above. The electrical energy storage unit is, for example, a battery which can have one of the above nominal voltages.

The invention will be better understood on reading the description that follows of non-limiting exemplary embodiments thereof:

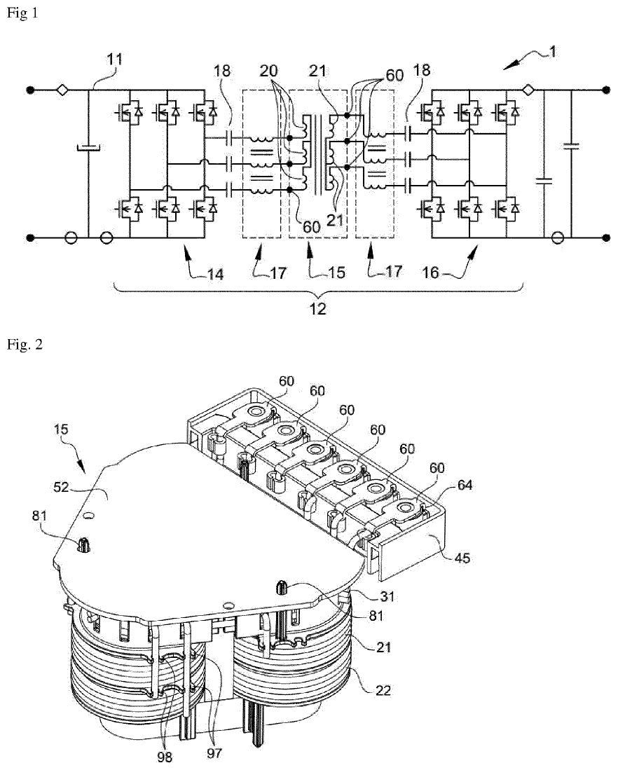

FIG. 1 schematically shows part of the electrical circuit of a component for supplying electric power to a vehicle electrical energy storage unit,

FIG. 2 shows in elevation an example of a three-phase transformer which is able to be used in the circuit of FIG. 1,

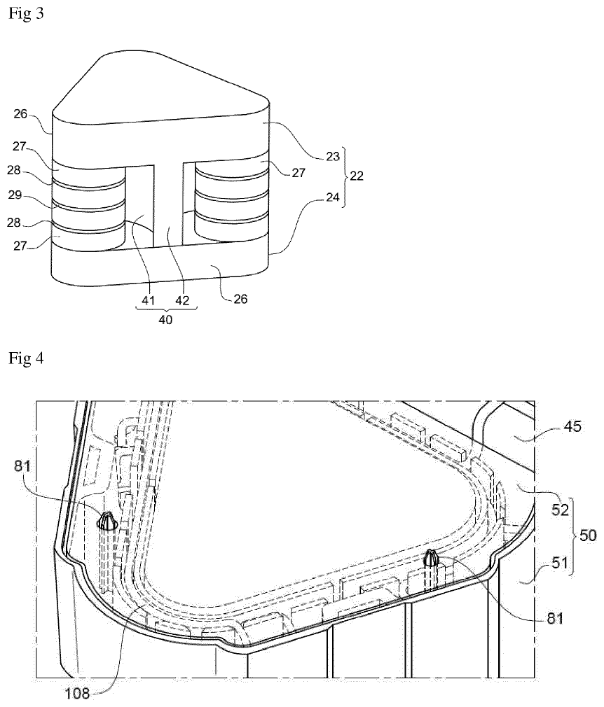

FIG. 3 shows in isolated fashion the magnetic circuit of the three-phase transformer of FIG. 2,

FIG. 4 partially shows the three-phase transformer of FIGS. 2 and 3 when the cover of the casing is removed,

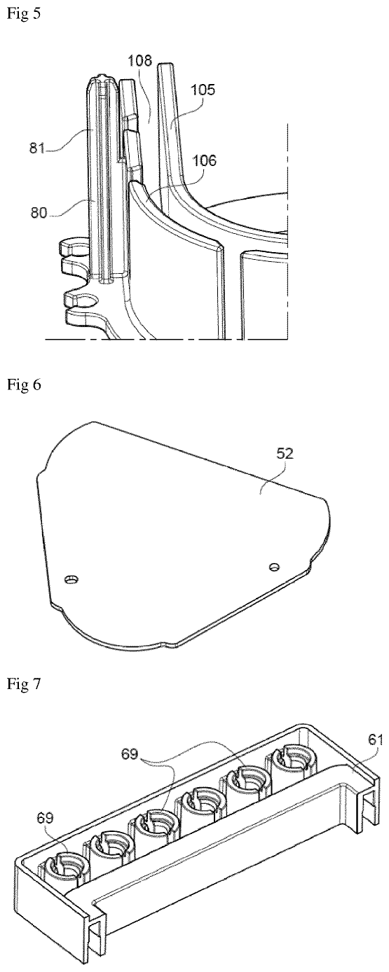

FIG. 5 shows a detail of an example of a system for holding the cover of the casing of the transformer on the support,

FIG. 6 shows the cover of the casing of FIG. 4,

FIG. 7 shows in isolation the body of the terminal block visible in FIG. 2,

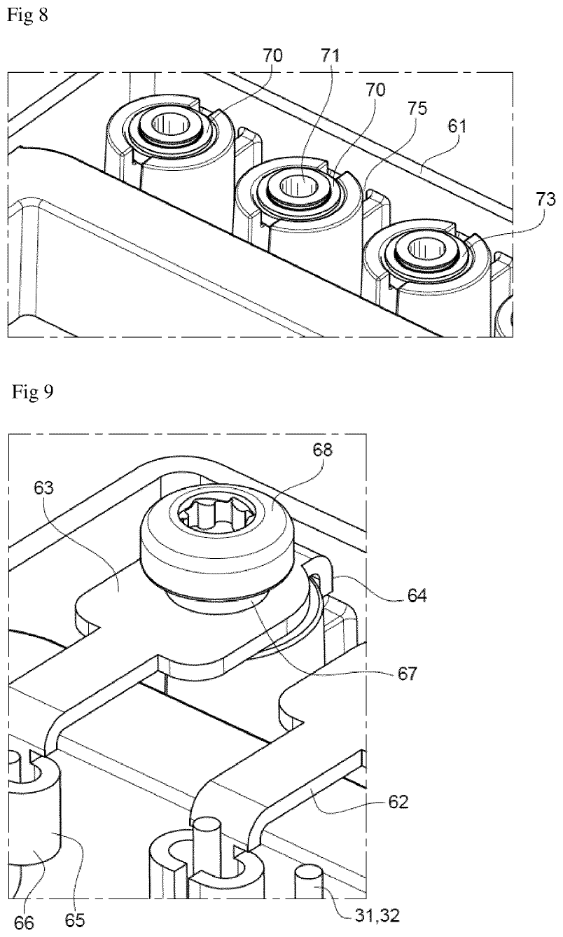

FIG. 8 shows the body of FIG. 7 in which inserts are arranged,

FIG. 9 shows the terminal block of FIGS. 7 and 8 with an electrically conductive bar and screw,

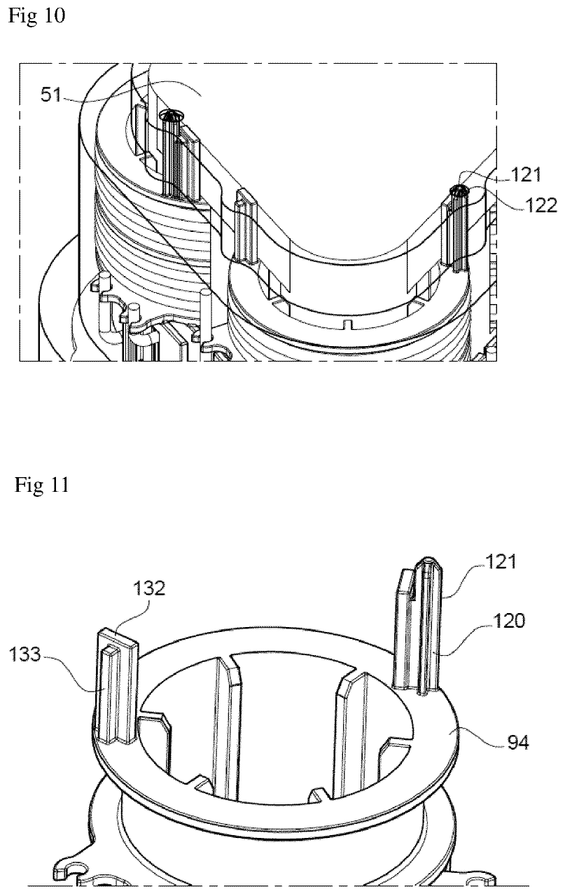

FIG. 10 shows that face of the transformer which is opposite that shown in FIG. 4,

FIG. 11 is a view of the support of the electrical conductors of the transformer from the same side as FIG. 10, and shows the holding system for holding the support on the magnetic circuit and the holding system for holding the support on the body of the casing of the transformer which are borne by this support,

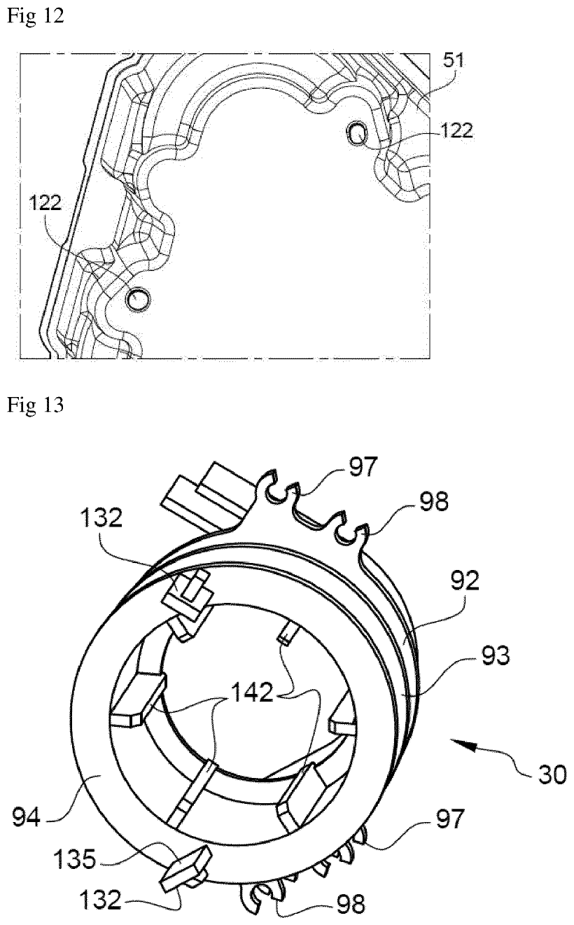

FIG. 12 shows the body of the casing of the transformer on which the support of the electrical conductors of FIG. 11 is kept,

FIG. 13 is a view similar to FIG. 11 and also shows ribs which make it possible for this support to extend away from the portion of the magnetic circuit on which it is mounted,

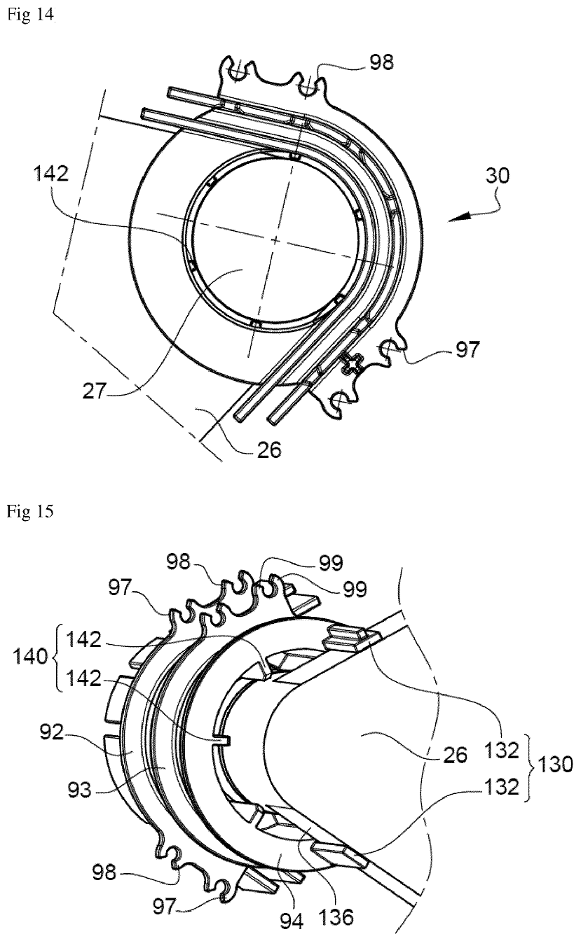

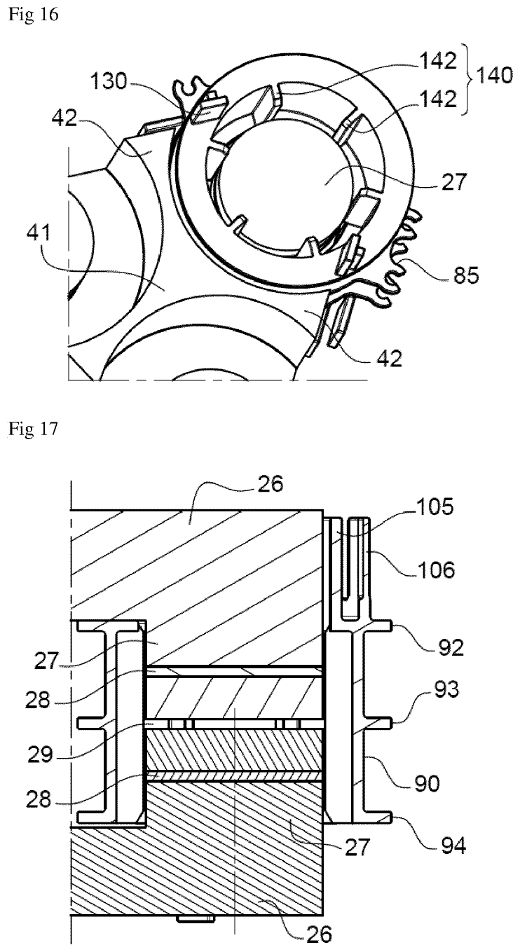

FIG. 14, FIG. 15 and FIG. 16 are views similar to that of FIG. 13 when the support of the electrical conductors is mounted on the portion of the magnetic circuit,

FIG. 17 is a cross-sectional view of FIG. 16,

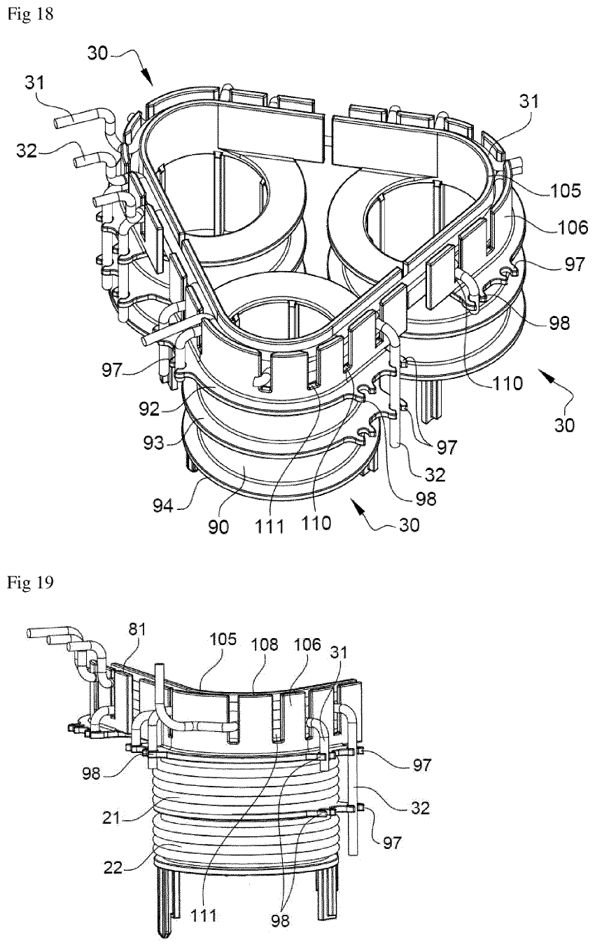

FIG. 18 shows three supports of the electrical conductors of the transformer and their electrical conductors, in the absence of the magnetic circuit,

FIG. 19 shows in isolated fashion one of the three supports of the electrical conductors from FIG. 18 with its electrical conductors, and

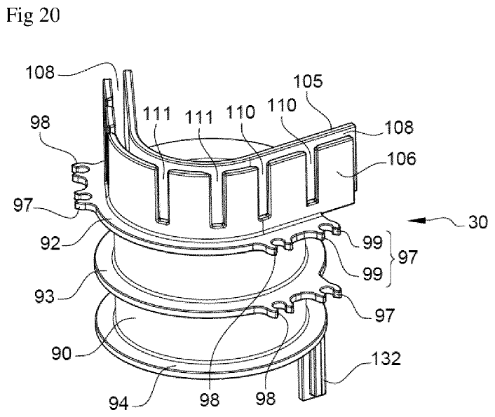

FIG. 20 shows the support of the electrical conductors from FIG. 19 without its electrical conductors.

FIG. 1 shows part of the electrical circuit 1 of a component for supplying electric power to a vehicle electrical energy storage unit. This component is also called a “charger”. The electrical energy storage unit, not shown in this FIG. 1, is, for example, a battery, which can have a nominal voltage greater than 60 V, for example greater than or equal to 300 V, 400 V, 800 V, or even 1000 V.

The circuit 10 receives at its input an AC voltage from a network which is not shown and which is three-phase here. A rectifier which converts this AC voltage into a DC voltage and, where applicable, also performs a power factor correction function is arranged upstream of a DC bus 11. Downstream of this DC bus, from the electrical network, an insulated voltage converter 12 is arranged, being a DC/DC here. This converter 12 comprises, in a known manner, an inverter 14, a three-phase transformer 15, and a rectifier 16 providing the vehicle with a DC voltage which is isolated from the electrical network. As can be seen in FIG. 1, the three-phase transformer 15 is connected to both the rectifier 16 and the inverter 14 by a block of inductors 17 and a block of capacitors 18, so as to define a CLLLC structure. Other structures are, of course, possible, such as an LLC, CLLC, LC or else CL structure.

As can be seen in FIG. 1, each phase has a primary winding 20 and a secondary winding 21 inductively coupled to one another, and the primary windings 20 are star-connected and the secondary windings 21 are also star-connected.

In the example considered, the three-phase transformer 15 comprises a magnetic circuit 22 comprising a first part 23 and a second part 24. Each part 23, 24 comprises: a base 26 of substantially triangular contour, and three pads 27 each extending in the direction of the base 26 of the other part of the magnetic circuit 22. Each base 26 has a contour defining an equilateral triangle here.

The transformer 15 further comprises three supports 30 of the electrical conductors 31, 32, each support 30 here being mounted on two facing pads 27 belonging to one and the other of the parts 23, 24 of the magnetic circuit, respectively. Two electrical conductors 31, 32 linked to one and the same support 30 have a portion defining a primary winding 20 and a portion defining a secondary winding 21, respectively. These electrical conductors 31, 32 are, for example, Litz wire.

As can be seen in FIG. 2, the three supports 30 of the electrical conductors 31, 32 are positioned so as to define an equilateral triangle.

The transformer 15 further comprises a casing 50 comprising a body 51 closed by a cover 52, which are visible in FIGS. 4 and 6. This body 51 and this cover 52 are, for example, made of metal, for example of aluminium. The supports 30 and the magnetic circuit 22 are arranged inside the casing 50. The body 51 is filled with a resin able to be polymerized to harden and immobilize the components arranged inside the casing (“potting”).

As can be seen in FIGS. 4 and 6, the casing 50 also has a triangular contour, being more precisely an equilateral triangle here. The casing is, in the example considered, exclusively formed by the body 51 and the cover 52 but the invention is not limited to a casing 50 made up of two parts.

As can be seen in FIG. 3, each pad 27 defines its own air gap 28, for example via an area of the pad 27 filled with non-magnetic material such as a composite of epoxy resin reinforced with glass fibre (FR4) or of ceramic. This area occupied by this non-magnetic material defines, for example, a whole slice of the pad. A plurality of sections are, for example, assembled with this area of the pad 27 to form this pad 27.

As can be seen in FIG. 3, an additional air gap 29 is present between the facing ends of two pads 27 belonging to different parts 23, 24 of the magnetic circuit 22, respectively. Thus, in the example of the magnetic circuit 22 considered, each magnetic field allowing inductive coupling between a primary winding 20 and a secondary winding 21 crosses exactly three air gaps.

Still in FIG. 3, it can be seen that the magnetic circuit 22 of the example considered comprises a central leg 40 supported by one of the parts 23, 24 of the magnetic circuit 22. This central leg 40 here is made in one piece with the part 23 of the magnetic circuit 22 which supports it.

It can be seen in FIG. 3 that the central leg 40 extends, in this example, continuously between two ends, each being in contact with one of the bases 26 of the magnetic circuit 22 so that no air gap is made in the central leg 40.

It can also be seen in FIG. 3 or in FIG. 16 that the central leg 40 has a core 41 and three protrusions 42 extending from this core 41, each protrusion 42 extending between two neighbouring pads 27 supported by one and the same part of the magnetic circuit.

As can be seen in FIG. 3, in the example considered, each pad 27 has a circular exterior contour, and each protrusion 42 of the central leg 40 here has a rounded wall facing the pads 27.

As can be seen in FIG. 2, the three-phase transformer 15 comprises a connection terminal block 45. This connection terminal block 45 is attached to one side of the casing 50 of the three-phase transformer 15. As can be seen in FIG. 2, the terminal block 45 here defines six terminals 60 for connecting the three-phase transformer 15 to the rest of the electrical circuit 10, these terminals 60 being shown schematically in FIG. 1. These terminals 60 here come into contact with electrical tracks of an electronic board which is not shown.

As can be seen in FIG. 2, the connection terminal block 45 has an elongated shape, and the six terminals 60 are arranged here in a row.

The various elements of the terminal block 45 according to this exemplary embodiment will now be described with reference to FIGS. 7 to 9.

The terminal block 45 here comprises a body 61 and a plurality of electrically conductive bars 62, each terminal 60 being defined by a portion 63 of a bar. Each portion 63 is planar here so as to come into contact with an electrical track of the electronic board mentioned above. The body 61 may be made of plastic, for example of PBT, PA, etc.

Each electrically conductive bar 62 has, for example, a portion 65, opposite the portion 63 defining the terminal, which is electrically connected to one of the electrical conductors 31, 32, here via a hollow sleeve 66 inside which the conductor 31, 32 is inserted, for example attached by crimping or welding.

Each electrically conductive bar 62 locally comprises a hole 67 and this electrically conductive bar 62 is attached to the body 61 by means of a screw 68 received in this hole 67. The body 61 here comprises six housings 69, and each of these housings receives an insert 70 which houses a hole 71, the above-mentioned screw 68 being received in an insert hole 71. Thus, the electrically conductive bar 62 is attached to the body 61 via the screw 68 and the insert 70 received in the housing 69. Each insert 70 may be made of metal, in particular of steel. As a variant, each insert is made of composite material. Six inserts are provided, for example, and, in the example considered, all these inserts 70 have the same shape and the same dimensions. Each screw 68 may, in addition to ensuring the attachment of an electrically conductive bar 62 to the body 61, also ensure the attachment of the electrically conductive bar 62 to the electronic board which is not shown.

As can be seen in FIG. 8, each insert 70 may define a positioning relief 73 for positioning the portion 63 of the electrically conductive bar defining the hole 67. This positioning relief 73 is, for example, a flat part of circular shape.

As can be seen in FIGS. 2, 7 and 8, the exterior wall of each housing 69 may house a recess 75 able to accommodate an end portion 64 of the electrically conductive bar 62 in order to ensure correct positioning of this bar on the body 61 and to prevent any relative rotation between this bar and this body.

In another exemplary embodiment which is not shown, the body 61 comprises a plurality of housings 69 which receive the screws 68 directly, in the absence of an insert 70. In this other exemplary embodiment, the electrically conductive bar 62 is attached to the body 61 directly via the screw 68, without an intermediate piece.

As can be seen in FIGS. 4 and 5, each support 30 of the electrical conductors may integrate a holding system 80 for holding the cover 52 on this support 30.

Each support 30 comprises, for example, a single pin 81 protruding with respect to the rest of the support 30 along the longitudinal axis of the latter. As a variant, only two of the three supports of the transformer 15 comprise a pin 81, the third support 30 being devoid of said pin.

FIG. 5 shows a pin 81 in detail, it being possible for the latter to have a section which is perpendicular to the longitudinal axis of the support and which is cruciform. Each pin 81 of a support 30 of the electrical conductors is, in the example considered, received by force in an opening made in the cover 52, as can be seen in FIG. 4. The relative arrangement of the pins 81 of the supports 30 makes it possible to immobilize the cover 52.

As can be seen in FIG. 5, the holding system 80 for holding the cover 52 on the support 30 may extend along the longitudinal axis of the support 30 on the same side of the support 30 as a guiding system 85 for guiding electrical conductors, which will be described with reference to FIGS. 18 to 20.

In these FIGS. 18 to 20, the holding system 80 is not shown, it being possible for the guiding system 85 to be present without necessarily the holding system 80 being present.

As can be seen in FIG. 18, each electrical conductor 31, 32 supported by a support 30 of the transformer 15 may be guided outside the winding 20, 21 that it defines.

In the example considered, each of these conductors 31, 32 is guided by the guiding system 85 beyond each of the ends of the electrical winding 20, 21 that it defines. As already mentioned above, the first ends of the electrical conductors may form an output towards the electrical circuit 10 outside the transformer 15, and three of the second ends of the electrical conductors may lead towards a common point via a star connection to the primary, and three others of these second ends of the electrical conductors may lead towards a common point via another star connection to the secondary.

The support 30 of the two electrical windings 31, 32 comprises:
a wall 90 around which the electrical windings 20, 21 are arranged, and this wall 90 defines, in the example considered but in a non-limiting manner, a hollow cylinder of circular cross section, and
three edges 92, 93, 94 offset along the longitudinal axis of the support so that one of the electrical windings 31 is arranged between the first 92 and the second 93 edge and that the other of the electrical windings 32 is arranged between the second 93 and the third 94 edge, as is clearly visible in FIG. 2 for example. The gap between two consecutive edges 92, 93 and 93, 94 remains constant in the example considered.

The guiding system 85 acts on the electrical conductors, on the one hand via clips 97 and 98, and on the other hand via additional walls 105 and 106.

In the example of FIGS. 18 to 20, the guiding system 85 comprises, for each electrical conductor 31, 32, on the one hand a first clip 97 cooperating with this electrical conductor 31, 32 beyond the first end of the electrical winding 20, 21 that it defines. Such a clip 97 has, for example, two curved arms 99 so as to fit closely with an area of the contour of this end of the electrical conductor, as shown in FIG. 18 or 20. A circular contour is involved in this case. Each clip 97 is, for example but in a non-limiting manner, made in one piece with the rest of the support 30 of the electrical conductors. As already explained, each first clip 97 cooperates, for example, with a portion of the electrical conductor 31, 32 on the way towards a connection terminal 60.

The guiding system 85 comprises, on the other hand, a second clip 98 cooperating with the electrical conductor beyond the second end of the electrical winding that it defines, these first 97 and second 98 clips coming one after another along one of the first 92, second 93 and third 94 edges. As already explained, each second clip 98 cooperates, for example, with a portion of the electrical conductor 31, 32 on the way towards a common point of a star connection.

More precisely, in the example considered:
the first edge 92 comprises two first clips 97 which each respectively cooperate with one of the electrical conductors 31, 32 beyond the first end of the electrical winding 20, 21 that it defines, and two second clips 98 which each respectively cooperate with an electrical conductor beyond the second end of this electrical winding 20, 21, and
the second edge 93 comprises a first clip 97, arranged beneath a first clip 97 of the first edge 92, and a second clip 98, arranged beneath a second clip 98 of the first edge. The clips borne by the second edge 94 make it possible to guide the electrical conductor 32 outside the electrical winding arranged between the second edge 93 and the third edge 94.

It can be seen in FIGS. 18 to 20 that two pairs of clips each formed of a first clip 97 and of a second clip 98 are found along the edge 92 and that the gap between two pairs of clips is greater than the distance between two clips of the same pair.

It can also be seen in these FIGS. 19 and 20 that the clips 97, 98 borne by the second edge 93 are aligned along the axis of the cylindrical wall 90 with clips 97, 98 borne by the first edge 92.

The two additional walls 105 and 106 of the guiding system 85 will now be described. These two additional walls 105 and 106 here are offset so as to define between them a guiding channel 108 receiving in a stacked manner the electrical conductors 31, 32 outside the windings 20, 21 that they define. The channel 108 has a constant dimension here. These additional walls extend, in the example considered, on both sides of an arc-shaped portion of the first edge 92, protruding axially beyond this first edge 92. In the area overlapping with this first edge 92, the additional walls 105 and 106 each define an arc-shaped portion, the wall 106 having a radius of greater than the wall 105, as is also visible in FIG. 17.

It can be seen in FIGS. 18 to 20 that the wall 106 comprises first openings 110 for the passage of the electrical conductors 31, 32 towards the electrical winding 20, 21 that it defines, and second openings 111 through which no electrical winding passes. It can be seen that the first openings 110 are arranged radially facing a clip 97, 98.

In the example of FIGS. 10 to 12, each support 30 of the electrical conductors 31, 32 also integrates a holding system 120 for holding onto the body 51 of the casing 50. This holding system 120 here comprises a pin 121 having, in this example, a section which is perpendicular to the longitudinal axis of the support and which is cruciform. This pin 121 extends axially away from the rest of the support 30 from the third edge 94. As can be seen in FIGS. 10 and 12, each pin 121 is received by force in an opening 122 made in the body 51 of the casing 50. This holding system may ensure that the magnetic circuit 22 is immobilized on the body 51 of the casing before the resin contained in this casing 50 polymerizes.

When such holding systems 120 exist, they may or may not be combined with the holding systems 80 and the guiding systems 85 mentioned above. As can be seen in FIGS. 10 to 12, each holding system 120 may thus extend axially from one side of the support 30 while the holding system 80 and the guiding system 85 extend axially from the opposite side of the support 30.

A functionality which may be integrated into all or some of the supports 30 of the electrical conductors 31, 32 will now be described with reference to FIGS. 13 to 15. A holding system 130 for holding the support 30 of the electrical conductors 31, 32 on the magnetic circuit 22 is thus provided. This holding system 130 is in the form of two blocks 132 protruding with respect to the rest of the support 30. When the holding system 120 is provided, these systems 130 and 120 may extend axially from the same side of the support, the pin 121 and a block 132 being in particular arranged side-by-side as can be seen in the example of FIG. 11.

Each block 132 here defines a surface 135 coming into contact with a surface 136 of a base 26 of the magnetic circuit 22. The surfaces 135 and 136 are planar here. Each block 132 is, for example, supported by a reinforcement 133, as can be seen in FIG. 11.

As can be deduced from FIG. 15, the cooperation between the two blocks 132 of a support 30 and the base 26 may ensure that the support 30 is immobilized with respect to rotation on the magnetic circuit 22.

Another functionality which can be integrated into all or some of the supports 30 of the electrical conductors 31, 32 will now be described with reference to FIGS. 13 to 16. It can be seen in these figures that the cylindrical wall 90 of the support 30 comprises ribs 142 extending away from the wall 90 in the direction of the pad 27 on which this support is mounted.

In the example considered, six ribs 142 are provided but the invention is not limited to a precise number of ribs 142. These six ribs 142 thus make up a spacing system 140 for spacing the cylindrical wall 90, and therefore the electrical windings 20, 21 that it bears, from the pad 27.

It can be seen in FIGS. 13 to 16 that all the ribs 142 may have the same shape and be distributed uniformly around the pad 27.

It can also be seen in these figures that each rib 142 may extend continuously along the axis of the support 30 from the first edge 92 up to the third edge 94.

In a variant which is not shown, all or some of the ribs extend discontinuously along the axis of the support 30.

As can be seen in FIG. 16, each rib 142 does not extend, for example, up to the pad 27 on which the support 30 is mounted. An empty space ensuring easy mounting thus remains present between each end of a rib facing the pad 27 and this pad 27.

As already mentioned, each support 30 of the electrical conductors 31, 32 may be made in one piece.

When this support 30 integrates:
the ribs 142, and/or
the holding system 80 for holding the cover 52 on the support, and/or
the guiding system 85 for guiding electrical conductors, and/or
the holding system 120 for holding the support on the body 51 of the casing, and/or
the holding system 130 for holding the support on the magnetic circuit 22,
all these systems may or may not be made in one piece with the rest of the support 30. In one particular example, the support 30 is thus in one piece and has all or some of the above-mentioned functionalities.

The invention is not limited to the examples that have been described above.

1. A three-phase transformer for an isolated voltage converter, comprising:
a magnetic circuit,
three supports of electrical conductors, each support being arranged around a portion of the magnetic circuit and bearing two windings inductively coupled to one another via the magnetic circuit the supports defining a geometric pattern of an equilateral triangle, each support comprising:
a wall around which the electrical windings are arranged, and
at least two ribs extending away from the wall in the direction of the portion of the magnetic circuit.

2. The transformer as claimed in claim 1, each support comprising four, or six, or eight ribs each extending away from the wall in the direction of the portion of the magnetic circuit.

3. The transformer as claimed in claim 2, the ribs being distributed uniformly while moving around the wall of the support.

4. The transformer as claimed in claim 1, each support comprising three edges offset along the longitudinal axis of the support so that one of the electrical windings is arranged between the first and the second edge and that the other of the electrical windings is arranged between the second and the third edge.

5. The transformer as claimed in claim 4, the two electrical windings supported by each support following one another along this support, without overlapping in planes perpendicular to the longitudinal axis of this support

6. The transformer as claimed in claim 4, all or some of the ribs extending continuously along the axis of the support from the first edge up to the third edge

7. The transformer as claimed in claim 1, all or some of the ribs extending up to the portion of the magnetic circuit with contact with this portion or with clearance.

8. The transformer as claimed in claim 1, the wall around which the electrical windings are arranged being cylindrical with a circular cross section.

9. The transformer as claimed in claim 1, each support being made in one piece.

10. The transformer as claimed in claim 1, no cooling chamber using a liquid being interposed between the electrical windings and the portion of the magnetic circuit on which the support arranged.

11. A component for supplying electric power to a vehicle electrical energy storage unit, comprising the transformer as claimed in claim

12. The transformer as claimed in claim 2, each support comprising three edges offset along the longitudinal axis of the support so that one of the electrical windings is arranged between the first and the second edge and that the other of the electrical windings is arranged between the second and the third edge.

13. The transformer as claimed in claim 5, all or some of the ribs extending continuously along the axis of the support from the first edge up to the third edge.

14. The transformer as claimed in claim 2, all or some of the ribs extending up to the portion of the magnetic circuit with contact with this portion or with clearance.

15. The transformer as claimed in claim 2, the wall around which the electrical windings are arranged being cylindrical with a circular cross section.

16. The transformer as claimed in claim 2, each support being made in one piece.

17. The transformer as claimed in claim 2, no cooling chamber using a liquid being interposed between the electrical windings and the portion of the magnetic circuit on which the support is arranged.

18. A component for supplying electric power to a vehicle electrical energy storage unit, comprising the transformer as claimed in claim 2.

19. The transformer as claimed in claim 3, each support comprising three edges offset along the longitudinal axis of the support so that one of the electrical windings is arranged between the first and the second edge and that the other of the electrical windings is arranged between the second and the third edge.

20. The transformer as claimed in claim 3, all or some of the ribs extending up to the portion of the magnetic circuit with contact with this portion or with clearance.
